(19) United States
(12) Patent Application Publication
(10) Pub. No.: US 2022/0354105 A1
(43) Pub. Date: Nov. 10, 2022

(54) INSECT REPELLENT LIQUID DISPENSER

(71) Applicant: Lamplight Farms Incorporated, Menomonee Falls, WI (US)

(72) Inventors: KYLE RESSLER, West Bend, WI (US); Ben Yu, New Berlin, WI (US)

(21) Appl. No.: 17/739,350

(22) Filed: May 9, 2022

Related U.S. Application Data
(60) Provisional application No. 63/186,048, filed on May 7, 2021.

(51) Int. Cl. A01M 29/12; H05B 1/02

(52) U.S. Cl. CPC A01M 29/12; H05B 1/0244

(57) ABSTRACT

An insect repellent device has a housing that fits onto a liquid repellent reservoir. The housing may have a heater for volatilizing the liquid insect repellent.

### CROSS-REFERENCE TO RELATED CASES

This application claims the benefit of U.S. provisional patent application Ser. No. 63/186,048, filed on May 7, 2021, and incorporates such provisional application by reference into this disclosure as if fully set out at this point.

### FIELD OF THE INVENTION

The present disclosure relates to insect repellent systems in general and, more particularly, to systems and methods for dispensing liquid insect repellents.

### BACKGROUND OF THE INVENTION

Insect repellents are widely used to keep outdoor areas free of biting and annoying insects. Repellents may be provided in a number of forms, including liquids. Liquids need to be dispersed into the local atmosphere over time to be effective.

What is needed is a system and method for addressing the above, and related, issues.

### SUMMARY OF THE INVENTION

The invention of the present disclosure, in one aspect thereof, comprises an insect repellent device having a reservoir with a liquid repellent therein, a wick extending into the reservoir that moves the liquid repellent from the reservoir and exposes it to air for volatilization, and a housing containing a heater. The housing fits onto the reservoir over the wick such that the heater is in proximity to the wick promoting volatilization of the repellent.

Some embodiments include a solar panel on the housing that powers the heater, and some include a battery in the housing that powers the heater.

The reservoir may remain at least partially exposed below the housing when the housing is fitted onto the reservoir. The reservoir may be at least partially translucent.

Some embodiments comprise a control circuit that activates and deactivates the heater.

The invention of the present disclosure, in another aspect thereof, comprises an insect repellent device having a housing containing a battery and having a solar panel affixed thereto, a heater in the housing powerable by the solar panel and by the battery, a reservoir having a wick extending therefrom, and a fitting between the housing and reservoir affixing the housing and reservoir together. Wherein, with the housing and reservoir affixed together, the heater is in sufficient proximity to the wick to raise a temperature thereof.

The device may include a liquid insect repellent received in the reservoir and wicked toward the heater by the wick. The insect repellent may be vaporized by the heater. The device may also include a control circuit interconnecting the solar panel and the battery for charging of the battery.

The invention of the present disclosure, in another aspect thereof, comprises an insect repellent device having a housing containing a heater, a reservoir that attaches to the housing by a fitting, a wick extending from proximate the heater into the reservoir, and a power supply. The heater heats the wick using power from the power supply to promote volatilization of a liquid insect repellent in the reservoir drawn therefrom by the wick.

In some embodiments, the power supply comprises a solar panel on the housing that powers the heater. The power supply may comprise a battery in the housing that powers the heater, and/or a connection to an external power source.

In some cases, the housing fits onto a top of the reservoir and the reservoir is visible below the housing. The reservoir may be at least partially translucent such that a quantity of repellent in the reservoir can be observed. The fitting may be a permanent connection

The housing may define at least one air passage therein extending between the wick and at least one vent. The repellent device may include at least one fan in the at least one air passage moving air from the wick to an area outside the housing. The device may include a control circuit that turns the power supply on and off.

### BRIEF DESCRIPTION OF THE DRAWINGS

FIG. 1 is a partially exploded perspective view of one embodiment of an insect repellent device according to aspects of the present disclosure.

FIG. 2 is a perspective view of another embodiment of an insect repellent device according to aspects of the present disclosure.

FIG. 3 is a partially exploded perspective view of one embodiment of an insect repellent device according to aspects of the present disclosure.

FIG. 4 is partially exploded perspective view of another embodiment of an insect repellent device according to aspects of the present disclosure.

FIG. 5 is a schematic diagram of another embodiment of an in sect repellent device according to aspects of the present disclosure.

### DETAILED DESCRIPTION OF THE PREFERRED EMBODIMENTS

According to embodiments of the present disclosure, liquid insect repellent dispensers are disclosed. These may disperse pyrethrin or pyrethroids such as metofluthrin, or other repellents or chemical products. The devices of the present disclosure may rely on evaporative dispersion, possibly utilizing heating or air flow to increase volatilization. Various embodiments of the present disclosure may utilize a liquid based repellent to be dispersed from a reservoir. Power to the devices may be provided by battery, household current, solar, or other means.

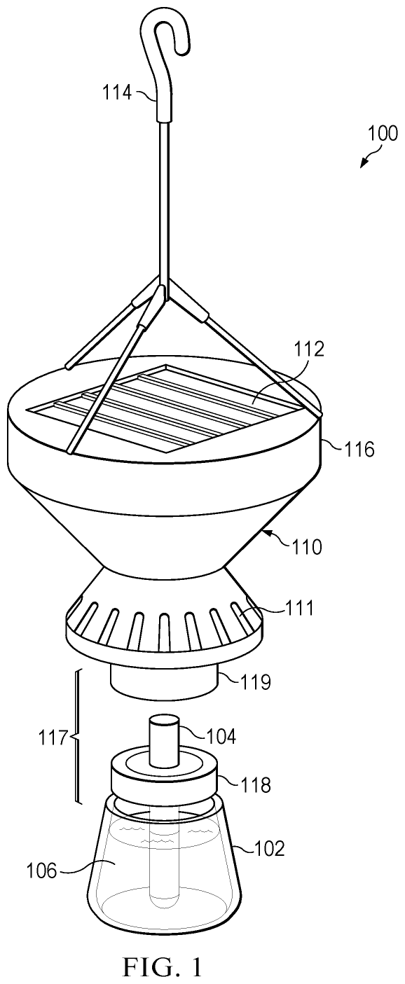

Referring now to FIG. 1, a partially exploded perspective view of one embodiment of an insect repellent device 100 according to aspects of the present disclosure is shown. The device 100 may comprise a liquid repellent reservoir 102 containing a liquid repellent 106 with a wick 104 extending into the reservoir, but remaining partially exposed from or out of the reservoir, to move the liquid repellent 106 out of the reservoir. The wick 104 may move the repellent 106 via capillary action or other wicking action and expose it to the atmosphere for dispersion, vaporization, or volatilization.

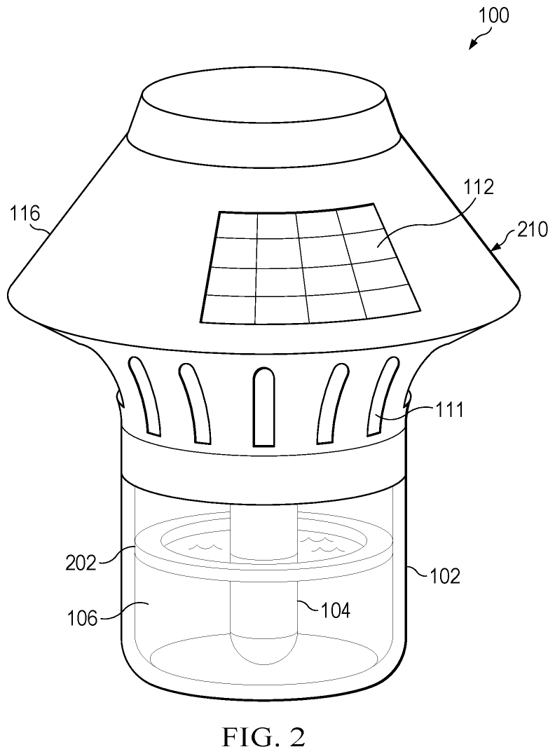

The reservoir 102 may be clear or translucent. In other embodiments the reservoir may be opaque but may also have a transparent or translucent window allowing viewing of a level of repellent 106 remaining therein. The reservoir may contain only the repellent 106 and the wick 104. In some embodiments, one or more floats (e.g., 202, FIG. 2) are provided to more easily indicate a fluid level in the reservoir 102. In other embodiments, the reservoir 102 may contain a sponge or another porous material (not shown) containing the repellent 106 but still allowing it to flow to and into the wick 106 for dispersal or volatilization.

The wick 104 may be woven wick of fiberglass or another material. The wick 104 may comprise polycrystalline cotton (PCC) or another material known to effective wick the repellent 106. In some embodiments the wick 104 may comprise a multi-layered arrangement such as a woven fiberglass sheath around a PCC core.

A top 110 of the repellent device 100 include a housing 116 having an appropriate shape or configuration to house and/or interconnect the various components of the device 100. The housing 116 may contain a battery and control circuitry as discussed further below. The housing 116 may comprise a polymer or another suitable material constructed according to methods known to the art.

The housing 116 may affix to the reservoir 102 (or the reservoir 102 affixes into or onto the housing 116) by a fitting 117 comprising a first fitting component 118 on the reservoir 116 and a second fitting component 119 on the housing 116. The fitting 117 may comprise a bayonet style connection, an interference fit (e.g., a snap fit), a threaded fitting, or other connection mechanism. In embodiments where there is no intention to replenish the repellent (e.g., the repellent supply lasts the intended life of the repellent device 100), the housing 116 may affix permanently to the reservoir 102.

The housing 116 may contain evaporation or volatilization enhancement or enablement features such as heaters or fans as discussed further below.

Vent openings 111 may be provided in the housing 116 to allow exit of the volatilized repellent out of the device 100. Power for operation of the fans or heating elements may be provided by a solar panel 112 located on the housing 116. The repellent device 100 may also provide a hanger 114 attached to the housing 116 to allow the repellent device 100 to be located in a convenient or useful area. The repellent device 100 can be affixed to a set of string lights, an outdoor torch, a dedicated hook or other device. The reservoir 102 may also be shaped such that the repellent device 100 is stable for sitting on a table or other surface on its own.

Referring now to FIG. 2 a perspective view of another embodiment of the insect repellent device 100 according to aspects of the present disclosure is shown. The reservoir 102 and or wick 104 may be substantially similar to those of the device 100 of FIG. 1. Here top 210 has a housing 116 provide similar function to that of FIG. 1 but it does not provide a hanger. Additionally, the solar panel 112 may be located in a different location. Vents 111 may be oriented or located differently as well. However, the solar panel 112 and vents 111 still provide a power supply and a means for dispersing volatilized repellents, respectively. Internal fans or heating elements may promote volatilization of repellent from the wick 104. It should be appreciated that the repellent device 100 of FIG. 2 may be placed on a solid surface or could be suspected by a separate hanger in a convenient location.

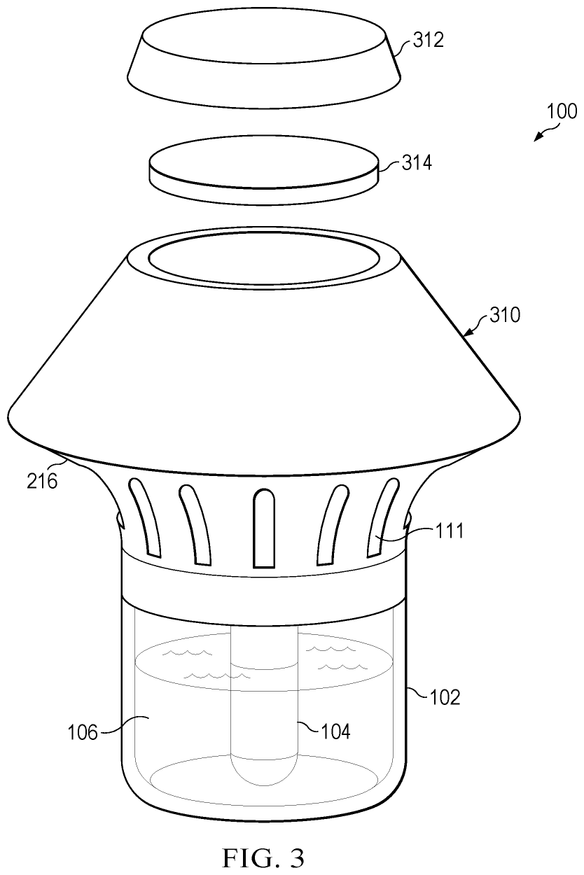

FIG. 3 is a partially exploded perspective view of another embodiment of the insect repellent device 100 according to aspects of the present disclosure. The device 100 as shown in FIG. 3 is substantially similar to that shown in FIG. 2 but for the use of a top 310 having a housing 116 configurated with a removable cap 312 allowing access to an internal replaceable battery 314 for powering internal heaters, fans and/r control circuitry. It should be appreciated that some embodiments may combine battery and solar power into a single top or device.

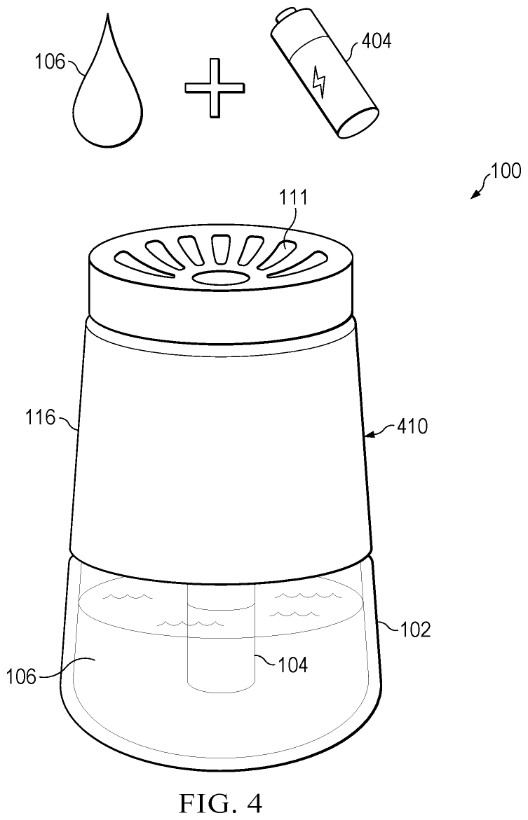

Referring now to FIG. 4 a partially exploded perspective view of another embodiment of the insect repellent device 100 according to aspects of the present disclosure is shown. As shown in FIG. 4, the device 100 is in an integrated replaceable/disposable configuration with a top 410 incorporating both repellent 106 and necessary power (e.g., batteries 404) within a housing 116. Battery capacity may be matched to expected conditions needed to volatilize all repellent in the reservoir 102 such that both will be depleted at approximately the same time. The device 100 as shown in FIG. 4 may be discarded or recycled after use. It should be understood though that the device 100 as shown in all embodiments may be provide with appropriate control and switching circuitry as are known in the art to enable them to be switched on and off and appropriately controlled.

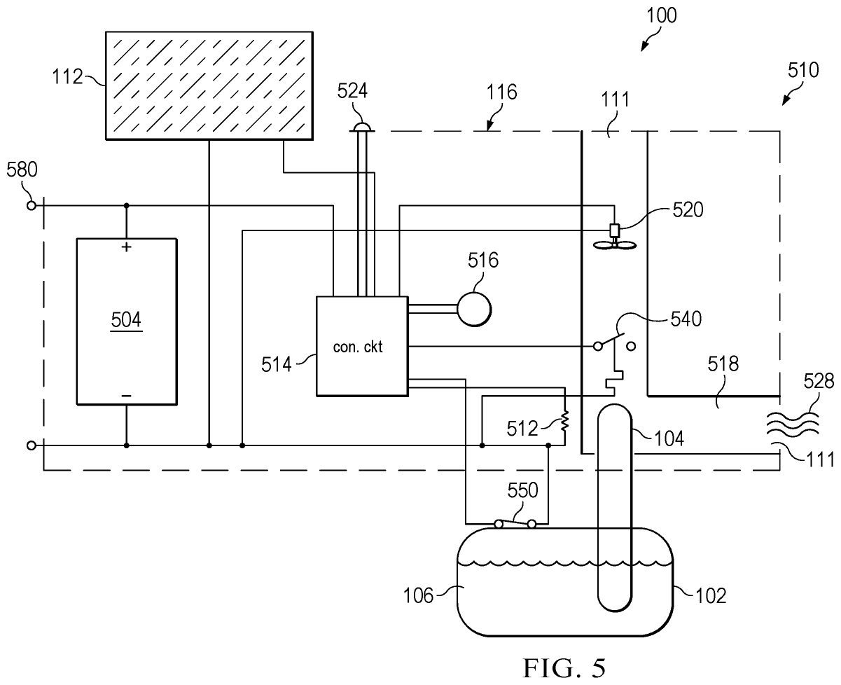

Referring now FIG. 5 a schematic diagram of another embodiment of an in sect repellent device 100 according to aspects of the present disclosure is shown. The schematic diagram of FIG. 5 is simplified to highlight certain features of various embodiments of insect repellent devices, systems, and methods of the present disclosure. One of skill in the art will readily and easily appreciate any additional needed components needed to realize the repellent devices, systems, and methods of the present disclosure in practice.

The repellent device 100 as illustrated in FIG. 5 provides a top 510 having a housing 116 shown in outline only. It should be understood that FIG. 5 is not intended to represent any particular physical appearance but functional relationships between various components. The reservoir can be seen to be fitted to the housing 116 in a manner such that the wick 104 is fitted into the housing 116. Internal air passages are represented by passage 518 allowing air to circulate on and around the wick 104 allowing for volatilization of the repellent 106 from the reservoir 102. Vaporize repellent 528 is shown escaping from an external vent 111 (though it should be understood that the repellent 528 may escape from a plurality of such vents 111 and/or via a plurality of air passages).

A heater 512 may comprise one or more resistive heating elements or other heating mechanisms. The heater 512 may have a ceramic or other coating. The heater 512 may be placed in proximity to the wick 104 to raise the temperature of the repellent 106 within the wick 104 allowing it to vaporize or volatilize.

A control circuit 514 may provide a number of functions within the device 100 including activation and deactivation of the heater 512. In some embodiments, the control circuit 514 comprises analog components but it may also comprise a silicon based digital controller. One of skill in the art will appreciate multiple ways to use a control circuit to implement the functions of the device 100 or others of the present disclosure.

In some embodiment, a temperature probe 516 is used by the controller to determine when the heater 516 should be activated (e.g., only in certain temperature ranges). In other embodiments, a thermostatic switch 540 near the wick 104 and/or heater 512 may be used to power on the device control circuit 514 and/or the heater 512. As shown, the thermostatic switch 540 powers the control circuit 514, which turns on the heater 512. However, some embodiments are further simplified such that the thermostatic switch 540 controls substantially all operation and the control circuit 514 may be substantially simplified or eliminated.

In some embodiments, a contact switch 550 activates the heater 540 and/or control circuit 514 when the reservoir 102 is attached to the housing 116. In some embodiments, the control circuit 514 is simplified or eliminated such that the contact switch 550 activates the heater 512 any time the reservoir 106 is attached to the housing 116.

Some embodiments have an off/off button or switch 524 connected to the control circuit 514 (if present). In some cases, the switch 524 simply connects or disconnects power from the entire internal circuity of the repellent device 100 (e.g., serving a as master switch).

As discussed above, devices of the present disclosure may be powered by solar and/or battery. As shown in FIG. 5, the repellent device 100 has both solar power from solar panel 112 and batter power from internal battery 504. The battery 504 may be rechargeable and may comprise any suitable chemistry. The battery 504 and may be use replaceable. Some embodiments have only battery power or only solar power. Some devices, instead, or additionally, have an external power connection 580 connecting to a sting light or other device that provides either a DC voltage or A/C line voltage. Such external power may connect directly to the heater 512 and/or via to the control circuit 514, which may allow for additional function beyond that available by on/off switches, thermostats, or contact switches.

As shown, the control circuit 514 may operate the heater 514 using any power source available to the repellent device 100. Additionally, the control circuit 514 may allow for charging of the battery 504 via solar power or otherwise. In some cases, the control circuit operates one or more status indicators (not shown) such as LED indicator lights, beepers, buzzers etc. These may provide visual or audible indication to the user that the device if powered on and operation normally, for example.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)—(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26 -100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. An insect repellent device comprising:
a reservoir having a liquid repellent therein;
a wick extending into the reservoir that moves the liquid repellent from the reservoir and exposes it to air for volatilization; and
a housing containing a heater;
wherein the housing fits onto the reservoir over the wick such that the heater is in proximity to the wick promoting volatilization of the repellent.

2. The insect repellent device of claim 1, further comprising a solar panel on the housing that powers the heater.

3. The insect repellent device of claim 1, further comprising a battery in the housing that powers the heater.

4. The insect repellent device wherein the reservoir remains at least partially exposed below the housing when the housing is fitted onto the reservoir.

5. The insect repellent device of claim 4, wherein the reservoir is at least partially translucent.

6. The insect repellent device 1, further comprising a control circuit that activates and deactivates the heater.

7. An insect repellent device comprising:
a housing containing a battery and having a solar panel affixed thereto;
a heater in the housing powerable by the solar panel and by the battery;
a reservoir having a wick extending therefrom; and
a fitting between the housing and reservoir affixing the housing and reservoir together;
wherein, with the housing and reservoir affixed together, the heater is in sufficient proximity to the wick to raise a temperature thereof.

8. The insect repellent device of claim 7, further comprising a liquid insect repellent received in the reservoir and wicked toward the heater by the wick.

9. The insect repellent device of claim 8, wherein the insect repellent is vaporized by the heater.

10. The insect repellent device of claim 7, further comprising a control circuit interconnecting the solar panel and the battery for charging of the battery.

11. An insect repellent device comprising:
a housing containing a heater;
a reservoir that attaches to the housing by a fitting;
a wick extending from proximate the heater into the reservoir;
a power supply;
wherein the heater heats the wick using power from the power supply to promote volatilization of a liquid insect repellent in the reservoir drawn therefrom by the wick.

12. The insect repellent device of claim 11, wherein the power supply comprises a solar panel on the housing that powers the heater.

13. The insect repellent device of claim of claim 11, wherein the power supply comprises a battery in the housing that powers the heater.

14. The insect repellent device of claim 11, wherein the power supply comprises a connection to an external power source.

15. The insect repellent device of claim of claim 11, wherein the housing fits onto a top of the reservoir and the reservoir is visible below the housing.

16. The insect repellent device of claim 15, wherein the reservoir is at least partially translucent such that a quantity of repellent in the reservoir can be observed.

17. The insect repellent device of claim 11, wherein the fitting is a permanent connection.

18. The insect repellent device of claim 11, wherein the housing defines at least one air passage therein extending between the wick and at least one vent.

19. The insect repellent device of claim 18, further comprising at least one fan in the at least one air passage moving air from the wick to an area outside the housing.

20. The insect repellent device of claim 11, further comprising a control circuit that turns the power supply on and off.
